(19) United States
(12) Patent Application Publication
(10) Pub. No.: US 2005/0052037 A1
(43) Pub. Date: Mar. 10, 2005

(54) Disposable pet waste glove

(76) Inventor: Paul A. Spuck, Bridgeview, IL (US)

Correspondence Address: LITMAN LAW OFFICES, LTD., P.O. BOX 15035 CRYSTAL CITY STATION, ARLINGTON, VA, 22215, US

(21) Appl. No.: 10/658,339

(22) Filed: Sep. 10, 2003

(51) Int. Cl. A01K 29/00; E01H 1/12

(52) U.S. Cl. 294/1.3

(57) ABSTRACT

The disposable pet waste glove is a glove worn on the hand of a person who is collecting and disposing of waste material. The glove cab be worn on either hand, and has a drawstring on the wrist portion of the glove. The drawstring serves to tighten the glove to the wrist and to help aid the wearer in pulling the glove off the hand, into an inverted position for enclosing the waste, and can be drawn tight and tied to contain the waste for disposal.

### BACKGROUND OF THE INVENTION

1. Field of the Invention

The present invention relates to waste collection and disposal systems, more particularly to disposable waste collection and disposal devices that conform to a user's hand and that can be used to pick up waste material without soiling the hand.

2. Description of the Related Art

Pet owners are faced with the unpleasant task of collecting and disposing of animal fecal material. In the past, pet owners have used pieces of paper, plastic shopping bags and rods to collect waste, however each method carries its own troubles. Paper is the simplest method used. A major disadvantage of using paper is that moisture seeps through, causing the paper to fall apart and soiling the owner's hand. Use of plastic shopping bags is beneficial in that it prevents wet matter from contacting the hand. However, plastic bags often slide over the hands, making it difficult to grasp waste matter. Opaque plastic bags hide the waste from the view of pet owner and force the pet owner to make several attempts to pick up the waste. The problem of using plastic bags is especially complicated when waste matter is wet because moisture causes waste to slip around.

Waste collecting rods have also been used to collect and dispose of waste. The problem with rods is that a rod is too cumbersome for the user to carry, especially when walking an overactive pet. Rods are meant to be reusable and, as a result, must be cleaned for sanitary reasons.

Other devices for disposing of animal waste have been developed that encase the entire hand, however they do not allow the user to readily control and collect the waste because the devices do not fit the thumb and each individual finger of the wearer. Additionally, these hand devices do not provide an easy and quick way to contain waste without soiling the user's hand. Although some hand encasing devices means for enclosing the waste for disposal, these devices require a lot of hand manipulation to enclose and contain waste. A need therefore exists for a device to conform to the user's hand, especially the thumb and each finger, allowing the user to readily grasp waste material. A need also exists for a device to contain waste and which is easily tied without soiling the user's hands, and that can be done in one simple step. Several devices have been proposed for collecting and disposing of waste matter.

U.S. Pat. No. 4,788,733, issued to Lerner on Dec. 6, 1988 describes a combined cleaning glove and disposal bag. The device is a thin plastic glove having three compartments: one for the thumb, one for the small finger and one for the remaining fingers. The glove is ambidextrous and has a tie at the wrist to secure the glove to the wrist and to contain the waste in the glove when it is turned inside out. The surface of the glove is covered with a towel layer that is infused with a cleaning solution.

U.S. Pat. No. 5,438,708, issued to Jacovitz on Aug. 8, 1995 describes a manual waste collection, containment and disposal glove. The glove has a sleeve that encases the lower arm and handles found at the end of the sleeve. The handles allow the wearer to pull the glove off the hand, in an inverted position, and to tie the inverted glove containing the waste. The palm of the glove has absorbent, non-absorbent or abrasive contact means.

U.S. Pat. No. 6,116,668, issued to Carpol on Sep. 12, 2000 describes a disposable waste collection garment that covers the hand as well as the wrist and lower arm. Two handles are provided at the end of the garment that covers the lower arm. The handles help invert the garment over the waste and provide a way to tie the garment in a self-contained compartment. A cleaning cloth is also found in a pouch placed on the forearm of the garment.

U.S. Pat. No. 6,481,766, issued to May et al. on Nov. 19, 2002 describes a glove-like disposal bag made of flexible plastic or rubber. The glove has a flexible bag positioned between the thumb and index finger that can be removed from the glove body to dispose of waste collected in the flexible bag. The glove has a cleansing pad and a sanitizing bar attached to its body to clean the soiled area once waste is removed. A flared wrist portion is attached to the base of the glove body. A drawstring is attached to the end of the wrist portion to close the glove around the wrist and to help tie and close the glove, containing the waste, once it is inverted.

Other patents showing waste disposal devices for the hand include U.S. Pat. No. 4,645,251, issued to Jacobs on Feb. 24, 1987 (two-layered glove waste disposal system); U.S. Pat. Nos. 4,964,188, 5,301,806, and Re. 35,814 issued to Olsen on Oct. 23, 1990, Apr. 12, 1994 and Jun. 2, 1998, respectively (glove that is heat-sealed into a plastic bag); United Kingdom Patent Number 2,231,027 (waterproof bag having a drawstring and adhesive material found at the bag's open end); United Kingdom Patent Number 2,100581 (scraper attached to a waste collecting bag).

None of the above inventions and patents, taken either singly or in combination, is seen to describe the instant invention as claimed. Thus a disposable pet waste glove solving the aforementioned problems is desired.

### SUMMARY OF THE INVENTION

The disposable pet waste glove is a hand device that allows the wearer to readily collect and dispose of waste material. The glove is ambidextrous and has four tubular finger sleeves, a thumb sleeve and a wrist portion possessing a drawstring. The drawstring serves to tighten the glove to the wrist of the wearer and to close and contain waste material collected by the glove once the glove is inverted inside out.

Accordingly, it is a principal object of the invention to provide a disposable pet waste glove that fits each individual finger and thumb of the hand.

It is another object of the invention to provide a disposable pet waste glove that has a drawstring to tighten the glove around the user's wrist, and to tie the glove closed around pet waste once it is inverted.

It is a further object of the invention to provide a disposable pet waste glove that provides a handle to carry the waste in the glove without soiling the hand.

Still another object of the invention is to provide a disposable glove that can contain waste material without soiling the hand of the wearer.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a disposable pet waste glove according to the present invention.

FIG. 2 is an environmental, perspective view of the disposable pet waste glove after picking up pet waste.

FIG. 3 is an environmental, perspective view of the disposable pet waste glove being removed from the user's hand.

FIG. 4 is an environmental, perspective view of the disposable pet waste glove of the present invention with the invention being completely pulled off the hand, the glove being inverted to enclose waste for disposal and the drawstring being pulled tight.

Similar reference characters denote corresponding features consistently throughout the attached drawings.

### DETAILED DESCRIPTION OF THE PREFERRED EMBODIMENTS

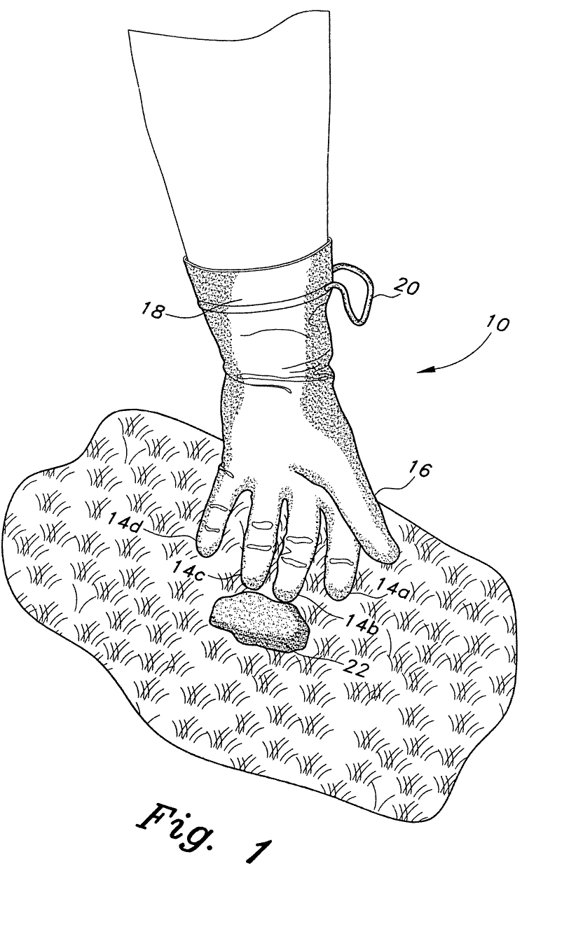

The present invention is a disposable pet waste glove, designated generally as 10 in FIGS. 1-4. Although the drawings show the glove 10 being worn on the left hand, the glove 10 is adapted to be worn on either hand. Referring first to FIG. 1, the glove 10 is has a front portion and a back portion connected to each other forming a sheath for encasing the dorsal and ventral aspects of a hand. The glove 10 is made preferably of thin plastic or other flexible material, such as latex. The glove 10 can be made of one piece of thin plastic or two pieces of thin plastic joined together.

The glove 10 has four tubular finger sleeves 14a, 14b, 14c, 14d, a thumb sleeve 16 and a wrist portion 18 extending from the sheath. By encompassing the thumb and each finger, the glove 10 allows the wearer to have manipulate objects between the fingers and to use each finger separately for grasping objects. This provides the user with maximum control over grasping waste, whether it is wet or dry. The wrist portion 18 encompasses the wrist and extends to cover a small portion of the lower arm, however, the wrist portion 18 is not limited to any particular length. A drawstring 20 is secured to the wrist portion 18 to selectively open and close the glove, i.e., to close the wrist portion around the user's wrist or arm so that one size glove fits all, and so that waste does not accidentally find its way into the glove 10, soiling the hand.

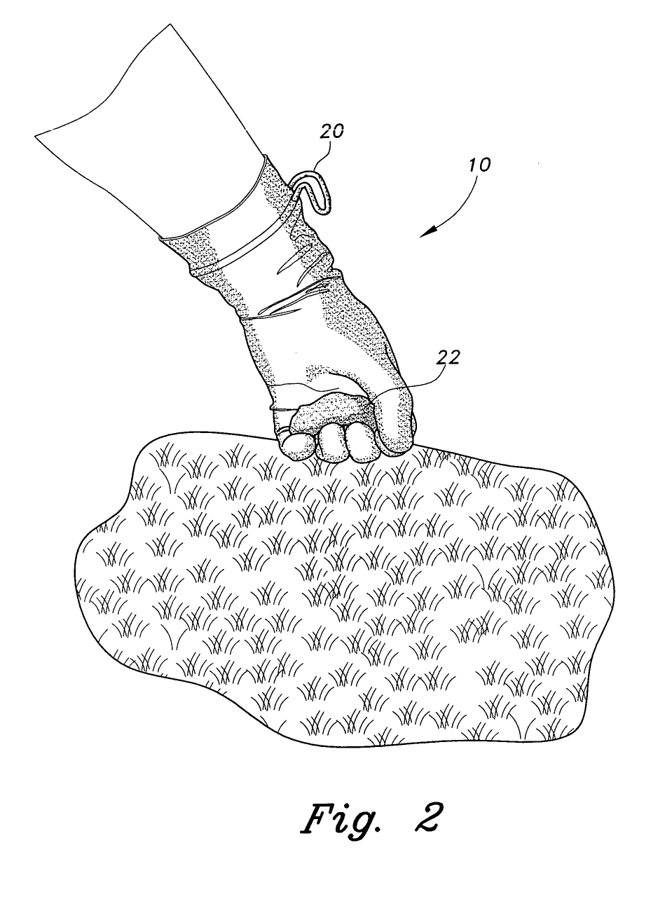

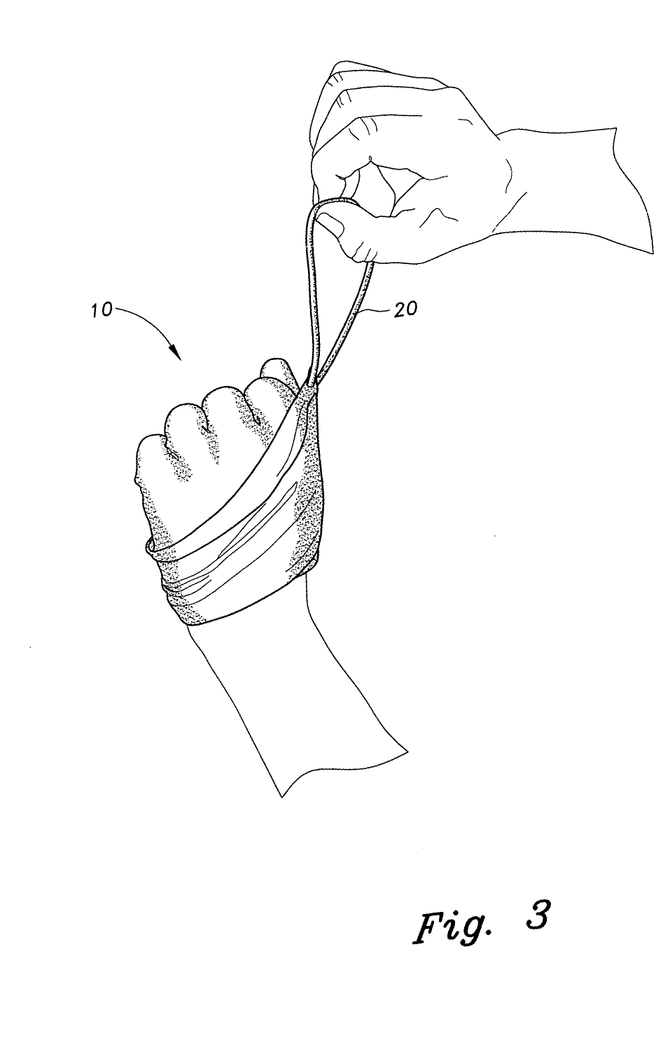

FIG. 2 shows the glove 10 lifting the waste material 22, which is held by the fingers, the thumb and the palm of the glove 10. Once waste material 22 is held in the glove 10, the wearer uses their free hand to pull the glove, via the drawstring 20, up and over the hand and fingers to invert the glove, as shown in FIG. 3. The drawstring 20 can be made of any suitable flexible material. If the drawstring 20 is formed in a closed loop, the user pulls the drawstring 20 with the free hand to cinch the wrist portion 18. If the drawstring 20 has two free ends then both hands may be used to tie the ends in a simple knot and close the wrist portion 18. The drawstring 20 tightens the wrist portion 18 to the wrist, encloses the wrist portion 18 of the inverted glove 10 containing waste matter, and serves as a handle for lifting and transporting the inverted glove 10.

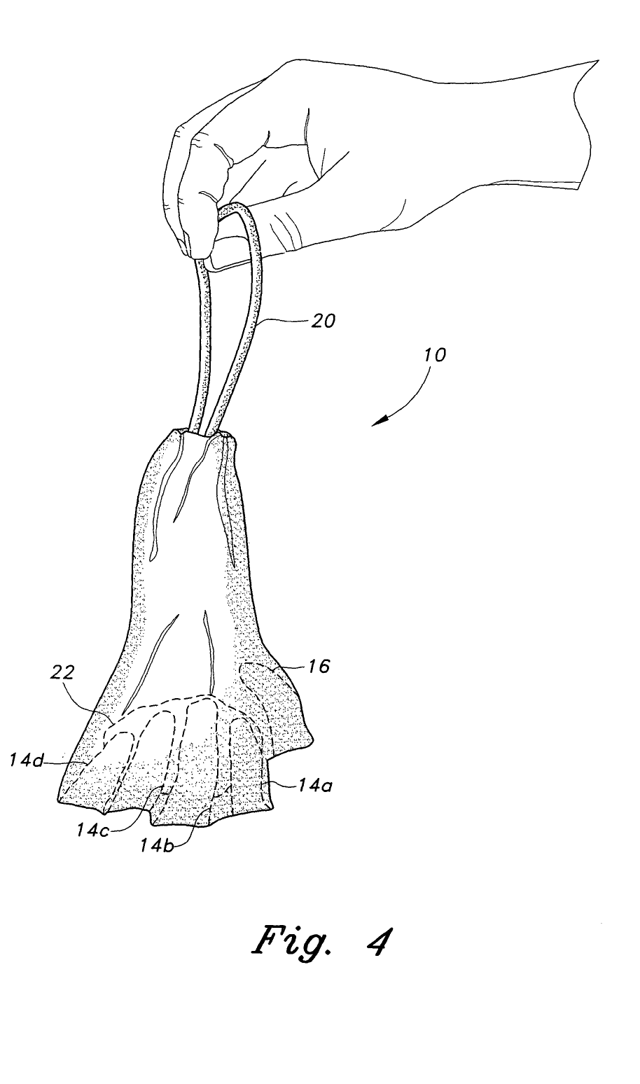

FIG. 4 shows the fully inverted glove 10 being held by drawstring 20 like a bag. The glove has been inverted, the interior of the glove 10 being exposed to form the exterior of the bag, the waste material 22 now being held within the glove 10. Here again, the drawstring 20 is used to close the glove 10 by either cinching or tying the glove at the wrist portion 18.

It is to be understood that the present invention is not limited to the embodiment described above, but encompasses any and all embodiments within the scope of the following claims.

1. A disposable pet waste glove, comprising:
a front portion and a back portion, the back portion being connected to the front portion to form a sheath adapted for encasing dorsal and ventral aspects of a hand;
a plurality of tubular finger sleeves extending from the sheath;
a thumb sleeve extending from the sheath;
a wrist portion extending from the sheath and terminating in an open end; and
a drawstring extending completely around the portion wrist adjacent the open end and forming a continuous loop external of the wrist portion;
whereby a user places the glove on the hand, picks up pet waste material with the gloved hand, turns the glove inside out by pulling the drawstring up over the hand and fingers and tightened the drawstring in order to contain the waste material within the glove for disposal.

2. The disposable pet waste glove according to claim 1, wherein said sheath is adapted for being worn on either hand.

3. The disposable pet waste glove according to claim 1, wherein said sheath, said finger sleeves, said thumb sleeves, and said wrist portion are made from latex.
